(19) United States
(12) Patent Application Publication
(10) Pub. No.: US 2009/0144685 A1
(43) Pub. Date: Jun. 4, 2009

(54) DOUBLE-LAYER INTEGRAL USING A STATIC GREEN'S FUNCTION AND RECTANGULAR BASIS

(76) Inventors: Lijun Jiang, Poughquag, NY (US); Jason D. Morsey, Hopewell Junction, NY (US)

Correspondence Address: HOFFMAN WARNICK LLC, 75 State Street, 14th Floor, ALBANY, NY, 12207, US

(21) Appl. No.: 11/754,539

(22) Filed: May 29, 2007

(51) Int. Cl. G06F 17/50

(52) U.S. Cl. 716/8

(57) ABSTRACT

The present invention a new closed-form double-layer integral for a rectangular basis. It is valid for both self integrals and non-self integrals. In general, the approach of the present invention contains only six (6) terms and is much simpler than indirect closed-form results, which has 24 terms.

### FIELD OF THE INVENTION

The present invention generally relates to a double-layer integral for rectangular basis. Specifically, the present invention relates to a double-layer integral using a static Green's function and rectangular basis.

### BACKGROUND OF THE INVENTION

The boundary element method (BEM) is popular and vital to many kinds of scientific applications, including integrated circuit (IC) physical design, mechanics, and computational fluid dynamics, etc. Due to similar physical principles behind different natural phenomena, the integral equations constructed from different physical procedures share many common features. In BEM, the object surfaces are discretized into triangular or rectangular patches, which are called basis. As to chip interconnect and packaging structures, rectangular basis are more efficient compared to triangular basis. One essential step in BEM, which directly affects the final accuracy and efficiency, is to construct and compute elements based on different integrals over various basis. Among them, the double-layer integral using a static Green's function is an important one for the direct boundary element method. However, direct numerical integrations for this integral give poor accuracy especially for bad aspect ratio cases. Since the closed-form integral solutions are more accurate and faster, it would be of great benefit to electronic design automation (EDA) and many other fields if they could be derived. Unfortunately, it is well-known that analytical closed-form solutions of integrals are very difficult to derive.

### SUMMARY OF THE INVENTION

The present invention provides a solution to the above-referenced problem(s) by providing here a new closed-form double-layer integral for a rectangular basis. It is valid for both self integrals and non-self integrals. In general, the approach of the present invention contains only six (6) terms and is much simpler than an indirect closed-form results (discussed below), which has 24 terms. Accordingly, the approach of the present invention is more efficient and easier to use.

A first aspect of the present invention provides an electronic design automation method, comprising: providing a rectangular basis for an integrated circuit design area; decomposing the rectangular basis into a first triangle and a second triangle; sequentially marking position vectors of vertexes of the first triangle; assigning values to the position vectors from a field point to the vertexes; and defining an edge vector of the first triangle.

A second aspect of the present invention provides an electronic design automation system, comprising: a module for providing a rectangular basis for an integrated circuit design area; a module for decomposing the rectangular basis into a first triangle and a second triangle; a module for sequentially marking position vectors of vertexes of the first triangle; a module for assigning values to the position vectors from a field point to the vertexes; and a module for defining an edge vector of the first triangle.

A third aspect of the present invention provides a program product stored on a computer readable medium for electronic design automation, the program product comprising program code for causing a computer system to: provide a rectangular basis for an integrated circuit design area; decompose the rectangular basis into a first triangle and a second triangle; sequentially mark position vectors of vertexes of the first triangle; assign values to the position vectors from a field point to the vertexes; and define an edge vector of the first triangle.

A fourth aspect of the present invention provides method for deploying a system for electronic design automation, comprising: providing a computer infrastructure being operable to providing a computer infrastructure being operable to: provide a rectangular basis for an integrated circuit design area; decompose the rectangular basis into a first triangle and a second triangle; sequentially mark position vectors of vertexes of the first triangle; assign values to the position vectors from a field point to the vertexes; and define an edge vector of the first triangle.

### BRIEF DESCRIPTION OF THE DRAWINGS

These and other features of this invention will be more readily understood from the following detailed description of the various aspects of the invention taken in conjunction with the accompanying drawings in which:

FIG. 1 show a rectangular basis according to the present invention.

FIGS. 2-3 show decomposed triangle according to the present invention.

FIG. 4 shows a computerized implementation of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description

II. Computerized Implementation

### I. General Description

As indicated above, the present invention provides a solution to the above-referenced problem(s) by providing here a new closed-form double-layer integral for a rectangular basis. It is valid for both self integrals and non-self integrals. In general, the approach of the present invention contains only six (6) terms and is much simpler than indirect closed-form results, which has 24 terms. Accordingly, the approach of the present invention is more efficient and easier to use.

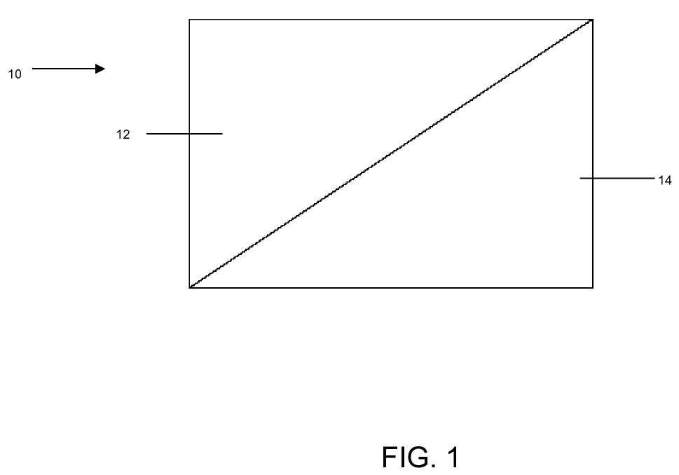

Referring now to FIG. 1 a rectangle basis 10 according to the present invention is shown. A field point r_{f} is off or on the rectangle. The integral utilized by the present invention is written as:

$$I = \frac{1}{4 π} {\int }_{s} \frac{\partial G ( r , {r}^{′} )}{\partial {n}^{′}} d {r}^{′}$$

where s indicates the integration region, which is a rectangle here. G(r, r′) is the Green's function defined as:

$$G ( r , {r}^{′} ) = \frac{1}{4 π \vert r - {r}^{′} \vert}$$

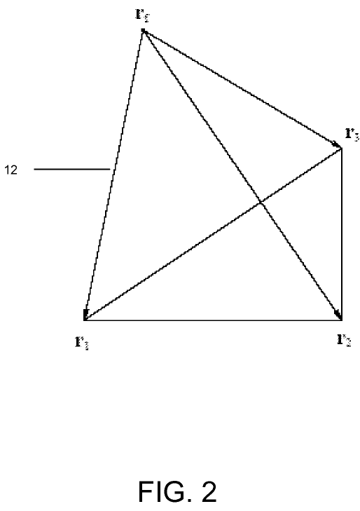

Under the present rectangle is decomposed into two rectangular triangles 12 and 14. Triangle 12 of them is shown in FIG. 2. As shown in FIG. 2 a position vector of vertexes of triangle 12 is marked to be r₁, r₂ and r₃ sequentially. Thereafter pᵢ (i=1, 2, 3) is assigned to the vectors from the field point r_{f} to those vertexes where:

vᵢ=rᵢ−r_{f}

vᵢ=|vᵢ|

where i=1, 2, 3. Further, an edge vector of triangle 12 is defined to be:

$${s}_{i} = {r}_{i + 1} - {r}_{i}$$

$${\hat{s}}_{i} = \frac{{s}_{i}}{\vert {s}_{i} \vert}$$

when i=3, ri+1=r1. If ̂n is set to be the norm vector of this triangle, we define

\hat{ξ}=−\hat{n}·rᵢ₊₁

Then the norm vector of each edge is written as

\hat{η}ᵢ=\hat{ξ}×ŝᵢ

ηᵢ=\hat{η}ᵢ·vᵢ

The solid angle of triangle 12 is defined as

$$Ω = \pm 2 {cos}^{- 1} [ \frac{{υ}_{1} {υ}_{2} {υ}_{3} + {υ}_{1} {v}_{2} \cdot {v}_{3} + {υ}_{2} {v}_{3} \cdot {v}_{1} + {υ}_{3} {v}_{1} \cdot {v}_{2}}{\sqrt{2 ( {υ}_{2} {υ}_{3} + {v}_{2} \cdot {v}_{3} ) ( {υ}_{3} {υ}_{1} + {v}_{3} \cdot {v}_{1} ) ( {υ}_{1} {υ}_{2} + {v}_{1} \cdot {v}_{2} )}} ]$$

+ is used when \hat{ξ} shares the same direct as the norm vector ̂n of the triangle. Or − will be used for the solid angle.

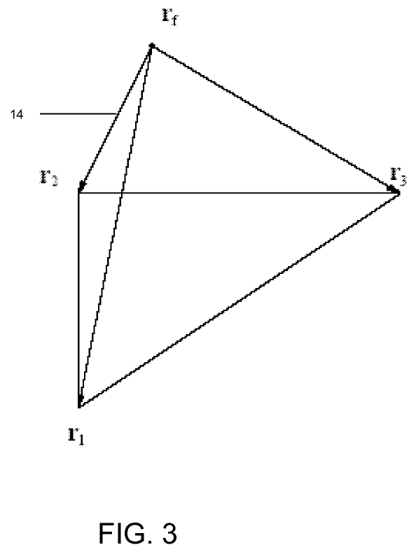

Regardless, the vertex position vector of the triangle 14 to be 1′, 2′, and 3′, as shown in FIG. 3. Following the definitions from the equations set forth above, another set of variables can be defined using similar names with prime symbols. Using them, the closed-form of the double-layer integral is derived to be:

$$I = \frac{1}{4 π A} {\sum }_{i = 1}^{3} [ {s}_{i + 1} {η}_{i + 1} Ω + {s}_{i + 1}^{′} {η}_{i + 1}^{′} {Ω}^{′} ]$$

where A is the area of this rectangle.

It should be understood that this solution can be applied to any boundary element method implementation using any programming language under any operating system.

### II. Computerized Implementation

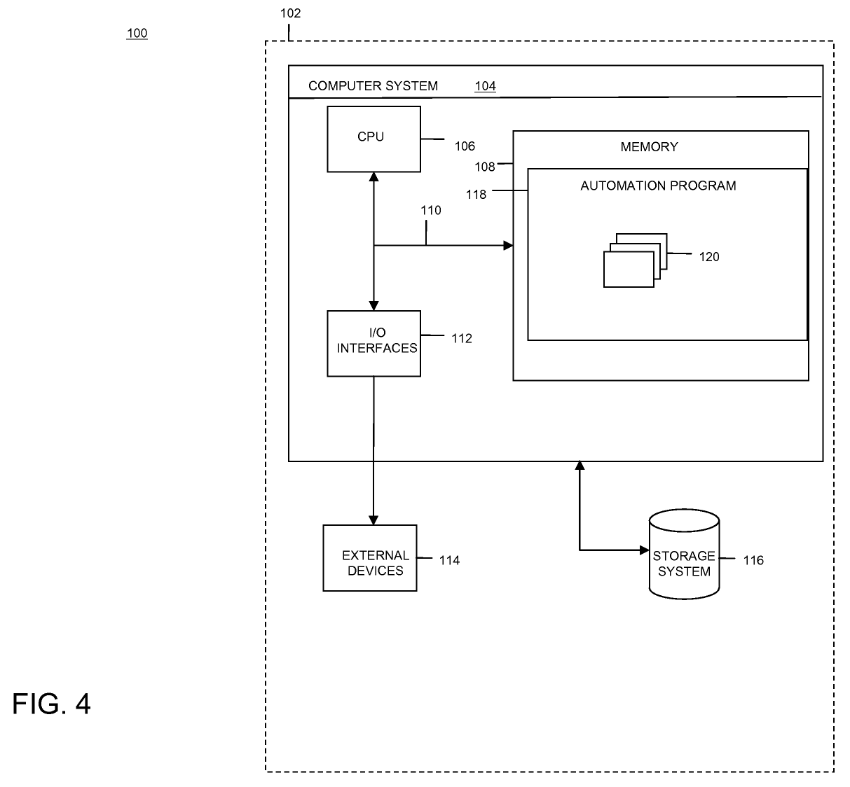

Referring now to FIG. 4, a computerized implementation of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, such as automation program 118, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any system for exchanging information with one or more external device 114. Still further, it is understood that one or more additional components (e.g., system software, math co-processing unit, etc.) not shown in FIG. 4 can be included in computer system 104. However, if computer system 104 comprises a handheld device or the like, it is understood that one or more external devices 114 (e.g., a display) and/or storage system 116 could be contained within computer system 104, not externally as shown.

Storage system 116 can be any type of system (e.g., a database) capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is automation program 118 having program modules 120, which provides the functions of computer system 104. These modules perform the functions and/or steps of the present invention as described above. These include, among others, providing a rectangular basis for an integrated circuit design area; decomposing the rectangular basis into a first triangle and a second triangle; sequentially marking position vectors of vertexes of the first triangle; assigning values to the position vectors from a field point to the vertexes; defining an edge vector of the first triangle; defining a vertex position vector of the second triangle; and/or determining the integrated circuit design area.

While shown and described herein as an electronic design automation method, it is understood that the invention further provides various alternative embodiments. For example, in one embodiment, the invention provides a computer-readable/useable medium that includes computer program code to enable a computer infrastructure to automate electronic design(s). To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 4) and/or storage system 116 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to automate electronic design(s). In this case, the service provider can create, maintain, support, etc., a computer infrastructure, such as computer infrastructure 102 (FIG. 4) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for automating electronic designs. In this case, a computer infrastructure, such as computer infrastructure 102 (FIG. 4), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as resource unit broker 28 (FIG. 4), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. An electronic design automation method, comprising:
providing a rectangular basis for an integrated circuit design area;
decomposing the rectangular basis into a first triangle and a second triangle;
sequentially marking position vectors of vertexes of the first triangle;
assigning values to the position vectors from a field point to the vertexes; and
defining an edge vector of the first triangle.

2. The electronic design automation method of claim 1, the values comprising pᵢ(i−1, 2, 3).

3. The electronic design automation method of claim 1, further comprising defining a vertex position vector of the second triangle.

4. The electronic design automation method of claim 3, the vertex position vector of the second triangle comprising 1′, 2′, and 3′.

5. The electronic design automation method of claim 4, further comprising determining the integrated circuit design area.

6. The electronic design automation method of claim 1, the position vectors comprising r₁, r₂, and r₃.

7. An electronic design automation system, comprising:
a module for providing a rectangular basis for an integrated circuit design area;
a module for decomposing the rectangular basis into a first triangle and a second triangle;
a module for sequentially marking position vectors of vertexes of the first triangle;
a module for assigning values to the position vectors from a field point to the vertexes; and
a module for defining an edge vector of the first triangle.

8. The system of claim 6, the values comprising pᵢ (i−1, 2, 3).

9. The electronic design automation system of claim 6, further comprising a module for defining a vertex position vector of the second triangle.

10. The electronic design automation system of claim 9, the vertex position vector of the second triangle comprising 1′, 2′, and 3′.

11. The electronic design automation system of claim 10, further comprising a module for determining the integrated circuit design area.

12. The electronic design automation system of claim 7, the position vectors comprising r₁, r₂, and r₃.

13. A program product stored on a computer readable medium for electronic design automation, the program product comprising program code for causing a computer system to:
provide a rectangular basis for an integrated circuit design area;
decompose the rectangular basis into a first triangle and a second triangle;
sequentially mark position vectors of vertexes of the first triangle;
assign values to the position vectors from a field point to the vertexes; and
define an edge vector of the first triangle.

14. The program product of claim 13, the values comprising pᵢ (i−1, 2, 3).

15. The program product of claim 13, further comprising defining a vertex position vector of the second triangle.

16. The program product of claim 15, the vertex position vector of the second triangle comprising 1′, 2′, and 3′.

17. The electronic design automation method of claim 16, the program product further comprising program code for causing the computer system to determine the integrated circuit design area.

18. The program product of claim 13, the position vectors comprising r₁, r₂, and r3.
